(19) United States
(12) Patent Application Publication
(10) Pub. No.: US 2013/0040113 A1
(43) Pub. Date: Feb. 14, 2013

(54) SCREEN PROTECTOR

(71) Applicant: Sheng-Chien CHAN, (US)

(72) Inventor: Sheng-Chien CHAN, (US)

(21) Appl. No.: 13/312,130

(22) Filed: Dec. 6, 2011

(30) Foreign Application Priority Data
Aug. 8, 2011 (TW) 100214702

(51) Int. Cl. B32B 3/00

(52) U.S. Cl. 428/195.1

(57) ABSTRACT

A screen protector is revealed. The screen protector includes a transparent protection film, an ink layer and a glue layer. The transparent protection film is made from flexible material and having an outer surface and an adhesive surface. The ink layer is a frame being printed around a periphery of the adhesive surface of the transparent protection film. The glue layer is disposed over the ink layer. By the glue layer, the screen protector is attached to a periphery of a screen and the screen is covered by the transparent protection film. Moreover, the manufacturing of the screen protector is more efficient and economic. There is no blank left around the periphery of the screen. The screen protector makes the screen look better and prevents the screen from scratches.

### BACKGROUND OF THE INVENTION

1. Field of the Invention

The present invention relates to a screen protector, especially to a screen protector used to protect screens of electronic devices, improve the appearance and enhance image quality.

2. Description of Related Art

Flat display devices have become the most popular digital equipment available now. For example, a plurality of electronics such as digital cameras, tablet computers, smart phones, etc. includes flat displays. Different from high hardness glass displays of conventional displays, the compact and light weighted panel of the flat display device is prone to abrasions and scratches while in use or during travel. Refer to Taiwanese Pub. No. 201027992—“MONITOR PROTECTION DEVICE FOR A FLAT PANEL DISPLAY”, a monitor protection device is disclosed. The monitor protection device includes a hard transparent sheet and a fixing film arranged around a periphery of the hard transparent sheet. The fixing film consists of a first surface and a second surface respectively connected to the periphery of the hard transparent sheet and the flat panel display. When the second surface of the fixing film is attached to flat panel display, there is a space between the hard transparent sheet and the flat panel display. Although the monitor protection device protects the display, it still has some shortcomings. For example, the fixing film is arranged at the hard transparent sheet and the second surface of the fixing film is coated layer. The manufacturing of the fixing film is time consuming and not economic. Moreover, a screen of the hot electronic devices such as tablet computers available now is generally a hard glass screen. Once the hard glass screen is disposed with the monitor protection device, the thickness is increased and the sense of quality is missing. And the adhesion between the two surfaces may be not good. Thus such monitor protection device is not suitable for tablet computers. And there is room for improvement and there is a need to develop a more convenient, economic and practical screen protector.

### SUMMARY OF THE INVENTION

Therefore it is a primary object of the present invention to provide a screen protector that protects the screen while in use. Moreover, the manufacturing of the screen protector is more efficient and economic so that the screen protector is more popular and more widely available.

It is another object of the present invention to provide a screen protector in which an ink layer is disposed by printing and adhesion stability is improved. Moreover, no blank is left around the periphery of the screen. Thus the screen looks better and the screen protector prevents the screen from scratches.

It is a further object of the present invention to provide a screen protector that is applied to the most popular electronics such as tablet computers, smart phones, etc., having screens made from high hardness glass. The design of the screen protector ensures the right time to market.

In order to achieve the above object, a screen protector of the present invention includes a transparent protection film, an ink layer and a glue layer. The transparent protection film, having an outer surface and an adhesive surface, is made from flexible material. The ink layer whose shape is like a frame is printed around the periphery of the adhesive surface of the transparent protection film. The glue layer is arranged over the ink layer. By the glue layer attached to the periphery of the screen, the transparent protection film is fixed on the screen tightly so as to provide protection.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a schematic drawing showing a cross section of an embodiment according to the present invention;

FIG. 3A is a schematic drawing showing a cross section of an embodiment during manufacturing processes according to the present invention;

FIG. 3B is another schematic drawing showing a cross section of an embodiment during manufacturing processes according to the present invention;

FIG. 4 is a schematic drawing showing an embodiment of the present invention in use;

FIG. 5 is another schematic drawing showing an embodiment of the present invention in use;

FIG. 6 is a schematic drawing showing an embodiment of the present invention attached to a tablet computer.

### DETAILED DESCRIPTION OF THE PREFERRED EMBODIMENT

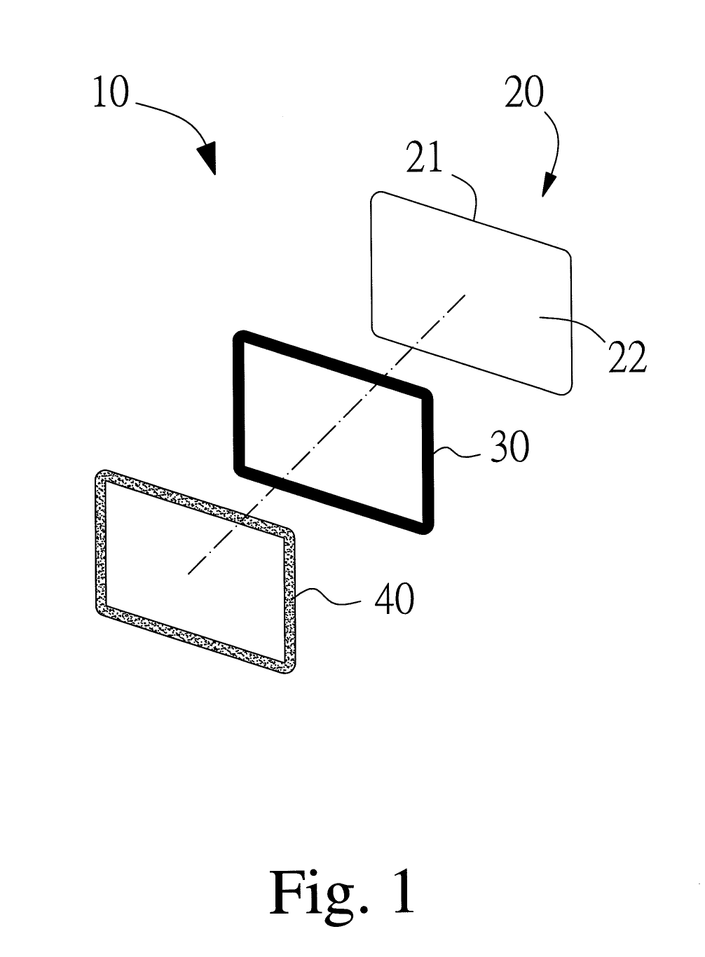

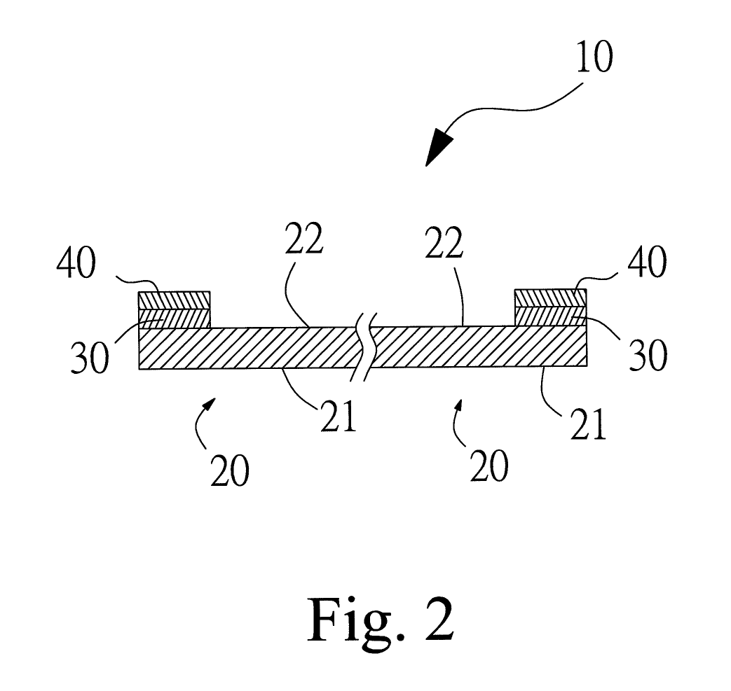

Refer to FIG. 1 and FIG. 2, a screen protector 10 of the present invention includes a transparent protection film 20, an ink layer 30 and a glue layer 40. The transparent protection film 20 is made from flexible or soft materials and having an outer surface 21 and an adhesive surface 22. The ink layer 30 is arranged around a periphery of the adhesive surface 22 of the transparent protection film 20. That means the ink layer 30 looks like a hollow ink frame. The ink layer 30 doesn't cover the whole adhesive surface 22. In an embodiment, the ink layer 30 is disposed around the adhesive surface 22 of the transparent protection film 20 by printing so as to achieve fast and easy manufacturing. The ink layer 30 is colored or added with colorants/pigments. The color of the ink layer 30 of the present invention is not limited while the black color is preferred. The glue layer 40 is an adhesive layer that is arranged at the ink layer 30 also by printing. The position of the glue layer 40 is the same with the position of the ink layer 30, also around the periphery of the adhesive surface 22 of the transparent protection film 20. The glue layer 40 is a silicone adhesive layer or a layer made from other adhesives. Moreover, after the screen protector 10 being produced, at least one surface of the screen protector 10 with the glue layer 40 is arranged with a release paper (not shown in figure). Or both surfaces of the screen protector 10 are respectively covered by a release paper.

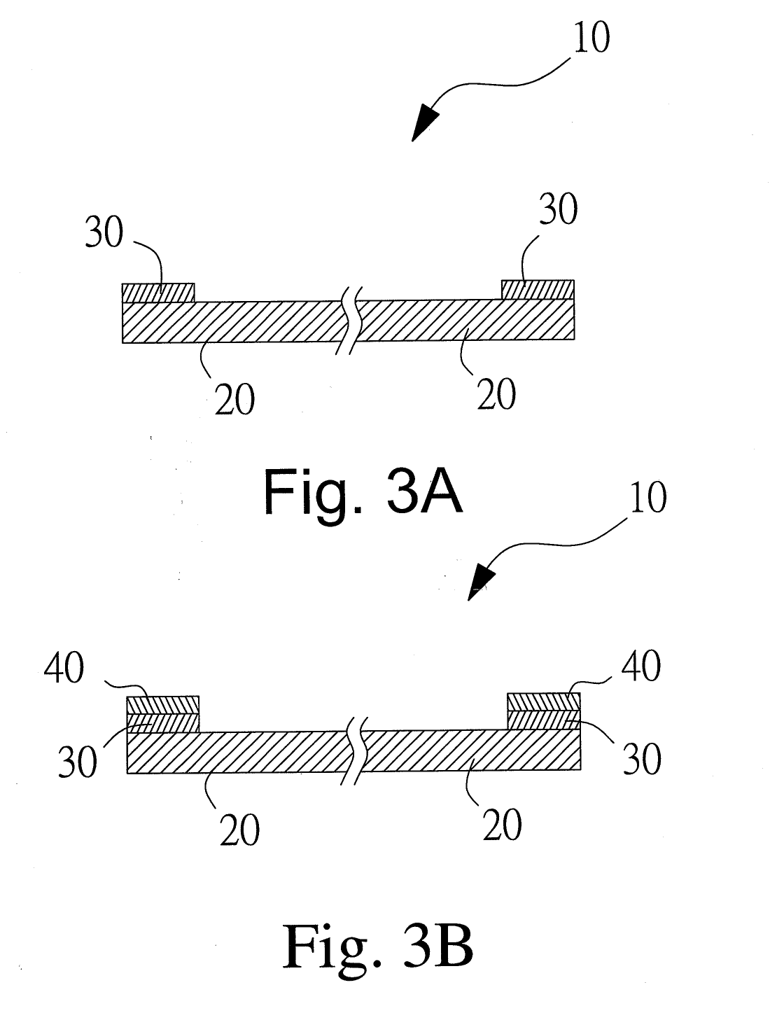

Refer to FIG. 3A and FIG. 3B, manufacturing processes of the screen protector 10 of the present invention are revealed. As shown in figures, take a transparent protection film 20 formed by cutting a roll of flexible or soft material. Or the transparent protection film 20 can be cut after being arranged with the ink layer 30 and the glue layer 40. The ink layer 30 is coated on the transparent protection film 20 by printing. The ink layer 30 is a frame arranged around the periphery on one surface of the transparent protection film 20. Next the glue layer 40 is coated on the ink layer 30 by printing. The shape of the glue layer 40 is similar to that of the ink layer 30, also like a frame around the surface of the transparent protection film 20. Thus the manufacturing of the screen protector 10 is completed.

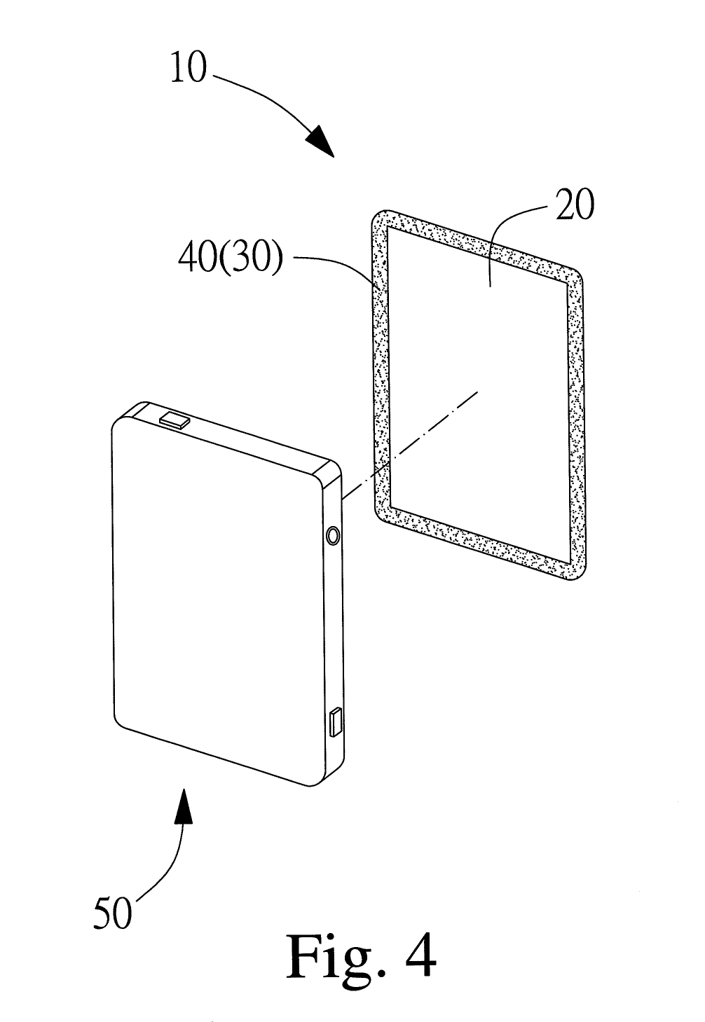

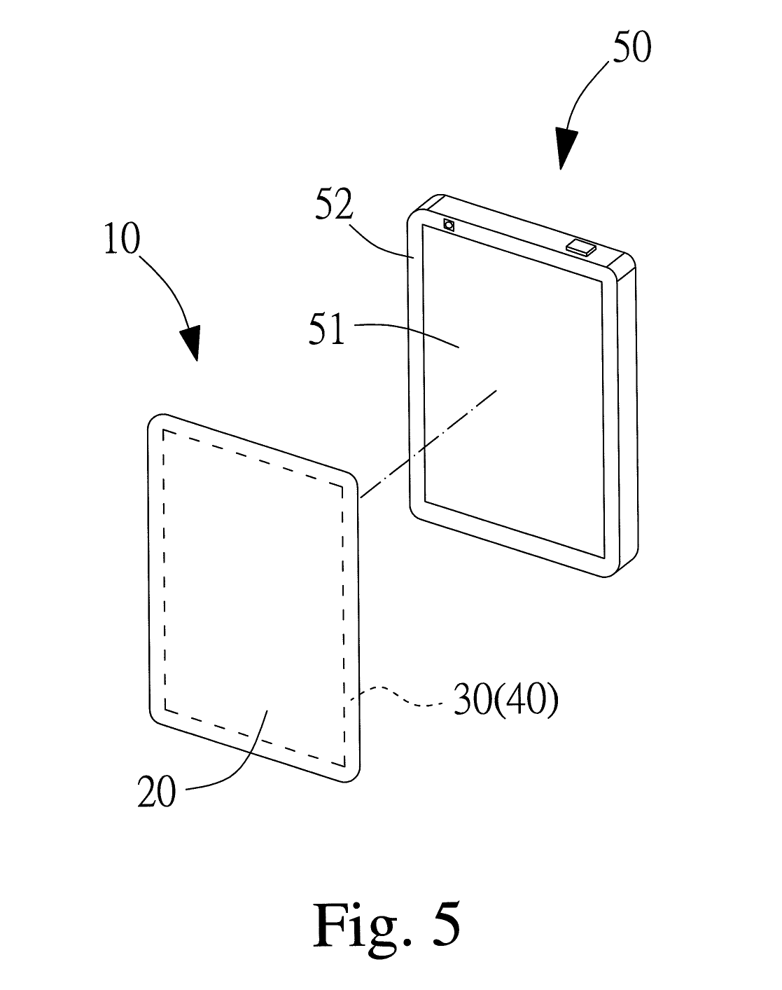

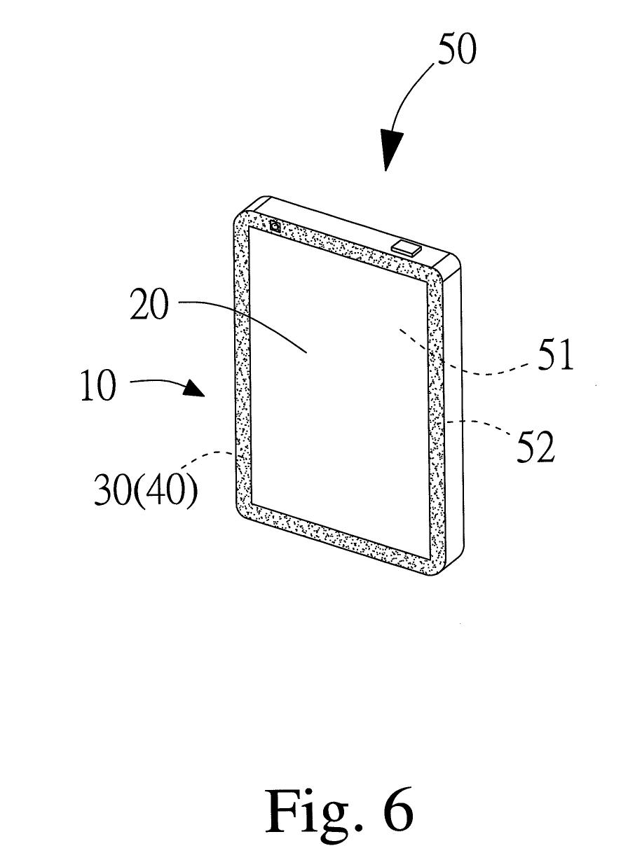

Refer to FIG. 4, FIG. 5 and FIG. 6, while in use, the adhesive surface 22 of the transparent protection film 20 disposed with the glue layer 40 is faced to a screen 51 of a tablet computer 50 and then the glue layer 40 is aligned with and attached to a frame 52 of the screen 51. The ink layer 30 and the glue layer 40 are thin printed layers so that the transparent protection film 20 can be covered over the screen 51 of the tablet computer 50 smoothly for preventing scratches and damages to the screen 51.

In summary, in the screen protector of the present invention, the ink layer is printed on the transparent protection film, and the glue layer is printed over the ink layer. Both the ink layer and the glue layer are frame-shaped. Besides protection of the screen while in use, the manufacturing of the screen protector is more efficient and economic and this increases the popularity of the product. Moreover, the adhesion stability is improved and no blank is left around the periphery of the screen. Thus the screen looks better. Furthermore, the transparent protection film made from soft or flexible material is suitable for use on hard glass screens of tablet computers or smart phones.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A screen protector arranged over a screen comprising:
a transparent protection film made from flexible material and having an outer surface and an adhesive surface,
a frame-shaped ink layer that is arranged around a periphery of the adhesive surface of the transparent protection film by printing; and
a glue layer disposed over the ink layer;
by the glue layer attached to a periphery of the screen, the transparent protection film is arranged at the screen so as to provide protection and beauty for the screen.

2. The device as claimed in claim 1, wherein the glue layer is a silicone adhesive layer.

3. The device as claimed in claim 1, wherein the glue layer is disposed over the ink layer by printing.

4. The device as claimed in claim 1, wherein the ink layer is in black color.

5. The device as claimed in claim 1, wherein the glue layer is arranged with a release paper.

6. The device as claimed in claim 1, wherein the glue layer is attached to a tablet computer and the tablet computer having a frame; the ink layer is corresponding to and aligned with the frame.
